(19) United States
(12) Patent Application Publication
(10) Pub. No.: US 2016/0257484 A1
(43) Pub. Date: Sep. 8, 2016

(54) THREE SHOES IN A SHOE BOX

(71) Applicant: Thomas John Barquinero, Bend, OR (US)

(72) Inventor: Thomas John Barquinero, Bend, OR (US)

(21) Appl. No.: 14/638,511

(22) Filed: Mar. 4, 2015

(51) Int. Cl. B65D 85/18; G06Q 90/00

(52) U.S. Cl. CPC B65D 85/187; G06Q 90/00

(57) ABSTRACT

One or more containers with three shoes in each container developed to distinctive yet compatible product design strategies and the method for manufacturing, marketing and selling these tri-sets of shoes. Containers will have one right and two left shoes or one left and two right shoes. Packaging shoes in this manner provides the purchaser with two pairs of shoes by combining one right shoe with either of the two left or one left shoe with either of the two right. Utilizing this method, purchasers of two or more shoe containers of a compatible product design family will obtain increasing multiples of mixed and matched pairs such as “buy two containers get nine pairs”, “buy three containers get twenty pairs”, “buy four get thirty six pairs” and so on with each subsequent container number purchase N=1→∞.

### CROSS REFERENCE TO RELATED APPLICATIONS

None

### STATEMENT REGARDING FEDERALLY SPONSORED RESEARCH OR DEVELOPMENT

None

### BACKGROUND OF THE INVENTION

The invention is a novel innovation in the millennia-old worldwide shoe industry—a large and competitive industry today that's estimated to achieve annual sales of $195 billion in 2015 according to global industry analysts. Today's shoe industry operates across international territories and cultures utilizing common trade standards and practices that have been honed over thousands of years based on the obvious fact that all people have two feet. As a result, from the early ages to the modern industrial era, shoes have always been worn as pairs so their makers have only designed, manufactured and marketed them in pairs as well.

Shoes have been around, in one form or another, for a very long period of time. Spanish cave drawings from more than 15,000 years ago show humans with animal skins or furs wrapped around their feet. The body of a well-preserved “ice-man” nearly 5000 years ago wears leather foot coverings stuffed with straw. Durable shoes are a relatively recent invention though many ancient civilizations wore ornamental footwear. The Romans saw footwear as signs of power and status. Their slaves, for example, always went barefoot. The Middle Ages saw the rise of high-heeled shoes, at first as a practical matter to keep your feet clean from muddy streets, but increasingly as a fashion statement where high heels were also associated with power & status. The term “well-heeled”, meaning being adorned in quality footwear, has been in the lexicon of many global cultures. Today, the most widely-accepted industry definition is that footwear refers to shoes being worn on the feet for both fashion and protection from the environment.

As noted throughout history, shoes have always been made, packaged and sold as a matched pair set—one right shoe, one left. This product combination of one right shoe and one left shoe, identically-made to match each other, has been a constant in the modern industrial era. This well-established standardization has been consistently applied across every facet and discipline of the shoe industry—a remarkable fact given the history of ever-changing market dynamics, the evolving materials and components utilized in shoe manufacturing and the different styles & types of shoe offerings introduced over the years. Two shoes in a shoebox has always been and continues to be the one-and-only single-sale product unit in the industry. That is, until now with the invention described in this patent application.

In today's world, people . . . as shoe consumers, constantly look for choice and value in the shoes they purchase. In turn, the trade industry . . . that is shoe manufacturers, distributors, wholesalers and retailers, execute in earnest to meet consumer demand with business tactics that are exclusively executed based on the standardized single-sale-unit of the matched paired set. However, the invention of this application creates a paradigm shift in the industry that will provide its trade with original ways to design, manufacture, market and sell shoes and, correspondingly, provide consumers with more choice and value in shoe product offerings.

### BRIEF SUMMARY OF THE INVENTION

The invention is the novel concept of packaging “three shoes in one shoebox” as a single-sale product unit in the millennia-old, $195 billion/year worldwide shoe industry. In the long history of this industry, there has only been one consumer purchase unit—that of the “two shoes in a shoe box” product, one right shoe and one matching left. It is how shoes have always been designed, manufactured, marketed and sold. As all people have just two feet, it is also obvious that the globally-established standard is that of the matched pair right & left shoe set. This invention changes that. It disrupts the status quo of the industry by providing a new “fashion-oriented” approach to how shoes can be made, marketed and sold . . . all for the benefit of shoe consumers and businesses alike.

The present invention is packaging three shoes in a shoe box or, more generally speaking, a shoe container of any kind for retail sale. This innovative packaging approach will affect all aspects of industry trade including the methods involved in product design, manufacturing, marketing and sales. The novel manners of each will be described in detail in the next section however their brief summaries are as follows: First, three shoes will be packaged in a container as either one right shoe & two left shoes or one left & two right. Second, all three shoes in that container will be developed to “distinctive yet compatible” product design tri-set strategies that will enable consumers to mix n' match the individual pairs they choose to wear at any given time. Third, distinct product design and packaging algorithms will be applied that will create robust sales opportunities such as “Buy 1 Shoebox. Get 2 Pairs of Shoes.”, “Buy 2. Get 9 Pairs.”, “Buy 3. Get 20.”, “Buy 4. Get 36.”, “Buy 5. Get 56.”, “Buy 6. Get 81 Pairs.” and so on with each multiple unit purchase in a compatible product design family.

### BRIEF DESCRIPTION OF THE SEVERAL DRAWINGS

None

### DESCRIPTION

Various embodiments of the methods will now be described. The following descriptions provide specific details for a thorough understanding and enabling description of these embodiments. It should be noted, however, that the above “Background” describes methodologies that may enable aspects and embodiments of the invention. One skilled in the relevant arts will understand, however, that the invention may be practiced without many of these details. Additionally, some well-known structures or functions may not be shown or described in detail, so as to avoid unnecessarily obscuring the relevant description of the various aspects and embodiments of the invention.

The terminology used in the description presented below is intended to be interpreted in its broadest reasonable manner, even though it is being used in conjunction with a detailed description of certain specific embodiments of the invention. Certain terms may even be emphasized herein; however, any terminology intended to be interpreted in any restricted manner will be overly and specifically defined as such in this Detailed Description section.

The major embodiment of the invention is the product concept of putting three shoes in one shoe box as a single-sale consumer-purchase unit. Heretofore, the shoe industry has only experienced the sole product concept of two shoes in one shoe box—that is a matched pair set consisting of one right and one left shoe. Putting three shoes in one shoe box will be a groundbreaking disruption in the industry. It has never been tried before in large part because it is not an obvious concept given people have just two feet. The impact of manufacturing, marketing and purchasing three shoes in one shoe box presents significant commercial opportunities and provides the consumer with additional choices and value from their purchase.

As shoes are sold in pairs, the industry standard for packaging said pairs has been the shoe box. The present invention embodies the packaging and selling of three shoes in a shoe box, however, the present invention encompasses any type of shoe container and the claims are directed toward any type of shoe container despite the description detailing just shoe boxes below. The word “container” in the descriptive language of the specifications encompasses any type of structure or arrangements that shoes are packaged in, such as plastic bags, tying shoes together etc. . . .

The present invention involves the packaging of more than two shoes in a container then utilizing a product design strategy to further enhance the marketability and utility of the shoe for the retailer and end user respectively. There are only four distinct ways to package three shoes in one shoe box. Two of those ways, include: 1) putting three right shoes in one shoe box; and 2) putting three left shoes in one shoe box. These packages are of limited-to-nil marketability as a single-unit-sale because they do not provide the consumer with a functioning pair of shoes to wear. However, the other two ways to package three shoes in one shoe box do provide wearable functionality and value-added product benefits.

The other two ways of packaging three shoes in a box are: 1) putting one right shoe and two left shoes in one shoe box; and 2) putting one left shoe and two right shoes in one box. These are identified by the following notations respectively: {RLL} and {LRR}. Each of these two single-sale units provides the consumer with two pairs of shoes to wear: by combining one right shoe with either of the two left shoes; or by combining one left shoe with either of the two right shoes. This offers choice and value to the consumer. Buy one shoebox or container. Get two pairs.

Given {RLL} and {LRR}, the next embodiment is to execute novel product design strategies that will give the consumer multiple options in mixing and/or matching the right and left shoes they choose to wear at any given time. Tri-sets will be developed to distinctive yet compatible design strategies that will offer fresh new opportunities affecting the fashion side of the industry which, in Western countries where shoe quality is firmly established with respect to protecting people's feet from environmental hazards, is the driving force between share-of-market growth or, for many companies, basic business survival. Individual shoe distinct designs are notated by numbers 1,2,3 . . . whereas {R1L2L3} is a tri-set package of one right shoe and two left shoes each with a distinctive yet compatible look or appearance. Same goes for its mirrored opposite {L1R2R3}. For example, shoe 1 could be a solid color, shoe 2 could be a necktie pattern in the solid's color palette and shoe 3 could have words, slogans, pictures or other creative expression. When a consumer purchases the one shoebox of {R1L2L3}, they get two mixed pairs to wear notated as [R1L2] and [R1L3]. If they purchase {L1R2R3}, they get mixed pairs [L1R2] and [L1R3]. In either case it's “Buy 1 Shoebox. Get 2 Pairs.”

The other method of “Buy 1 Get 2” packaging is a single tri-set container that provides a buyer with both a mixed and a matched pair notated by {R1L1L2} which yields [R1L1] and [R1L2] or {L1R1R2} which yields [L1R1] and [L1R2]. One example is that these mix n' match applications are particularly appealing in the business of marketing shoes to colleges and fans of sports teams in their favorite team colors, logos, etc. In this example, a buyer gets a conventional matching pair of shoes to wear on a regular basis plus a mixed team-oriented version that's perfect for game day.

The third embodiment combines product design and packaging algorithms that create new retail sales opportunities when consumers purchase multiple 3-in-1 shoe containers. This concept promotes volume sales and viral word-of-mouth on limited edition tri-sets and on-going perennial tri-sets of distinctive yet compatible design strategies. The algorithms or formulas notated below identify the two methods of packaging two separate shoe containers with three shoes each in order to create the sales claim “Buy 2 Shoeboxes. Get 9 Pairs”.

The first buy-2-get-9 algorithm creates 3 matching and 6 mixed pairs of shoes. It is notated as follows:

$$\begin{matrix}\{ R 1 L 2 L 3 \} & + & \{ L 1 R 2 R 3 \} \\ & yields & \\ [ R 1 L 1 ] & [ R 2 L 2 ] & [ R 3 L 3 ] \\ [ R 1 L 2 ] & [ R 2 L 1 ] & [ R 3 L 1 ] \\ [ R 1 L 3 ] & [ R 2 L 3 ] & [ R 3 L 2 ]\end{matrix}$$

Please note that these two shoeboxes are their mirrored tri-sets which is the reason it yields both matching and mixed pairs of shoes. The other algorithm is designed to create only mixed pairings.

The second buy-2-get-9 algorithm creates nine mixed pairs of shoes and is notated as follows:

$$\begin{matrix}\{ R 1 L 2 L 3 \} & + & \{ L 4 R 5 R 6 \} \\ & yields & \\ [ R 1 L 2 ] & [ R 1 L 3 ] & [ R 1 L 4 ] \\ [ R 5 L 2 ] & [ R 5 L 3 ] & [ R 5 L 4 ] \\ [ R 6 L 2 ] & [ R 6 L 3 ] & [ R 6 L 4 ]\end{matrix}$$

This distinctive yet compatible product design family approach offers the utmost in creative possibilities, a highly sought after attribute in what is a largely fashion-driven industry. It should be noted that introducing the concept of wearing mixed pairs of shoes, as opposed to the current standard matching pair, will extend popular apparel concepts people adorn today such as accessorizing their outfits with compatible mix n' matched scarfs, ties, handbags and socks.

Both of the Buy 2 Get 9 formulas extend beyond the purchase of just two shoe containers. Their algorithmic equations cover all multiple tri-set shoebox purchases from purchase units N=1→∞. In this manner, it establishes the novel marketing claims of “Buy 1 Shoebox. Get 2 Pairs of Shoes.”, “Buy 2. Get 9 Pairs.”, “Buy 3. Get 20.”, “Buy 4. Get 36.”, “Buy 5 Get 56”, “Buy 6. Get 81 Pairs.” and so on. A summary notation is as follows:

### Mix n' Match Buy 3 Get 20

{R1L2L3}+{L1R2R3}+{R4L5L6}

[20 pairs by mating each of the 4 right shoes R1-R4 with each of the 5 left shoes L1-3 & L5-6]

### All Mixed Buy 3 Get 20

{R1L2L3}+{L4R5R6}+{R7L8L9}

[20 pairings: each of the 4 right shoes R1 & R5-7 with each of the 5 left shoes L2-4 & L8-9]

### Mix n' Match Buy 4 Get 36

{R1L2L3}+{L1R2R3}+{R4L5L6}+{L4R5R6}

[36 pairs by mating each of the 6 right shoes R1-R6 with each of the 6 left shoes L1-L6]

### All Mixed Buy 4 Get 36

{R1L2L3}+{L4R5R6}+{R7L8L9}+{L10R11R12}

[36 pairs: the 6 right shoes R1, R5-7, R11-12 with each of the 6 left shoes L2-4 & L8-10]

### Mix n' Match Buy 5 Get 56

{R1L2L3}+{L1R2R3}+{R4L5L6}+{L4R5R6}+{R7L8L9}

[56 pairs: the 7 right shoes R1-R7 with each of the 8 left shoes L1-L6 & L8-9]

### All Mixed Buy 5 Get 56

{R1L2L3}+{L4R5R6}+{R7L8L9}+{L10R11R12}+{R13L14L15}

[56 pairs: 7 right shoes R1, R5-7, R11-13 with the 8 left shoes L2-4, L8-10, L14-15]

### Mix n' Match Buy 6 Get 81

{R1L2L3}+{L1R2R3}+{R4L5L6}+{L4R5R6}+{R7L8L9}+{L7R8R9}

[81 pairs: the 9 right shoes R1-R9 with the 9 left shoes L1-L9]

### All Mixed Buy 6 Get 81

{R1L2L3}+{L4R5R6}+{R7L8L9}+{L10R11R12}+{R13L14L15}+{L16R17R18}

[81 pairs: 9 right shoes R1, R5-7, R11-13, R17-18 with 9 left shoes L2-4, L8-10, L14-16] The above two mix n' match multiple shoe containers-to-pairings formulas extend accordingly with each subsequent shoebox unit N=1→∞ purchase.

Lastly it should be noted that, but its very nature, distinctive yet compatible product design strategies are broad in application. A design strategy could be developed in a finite container limited edition tri-set family of containers. Or it can be developed as a perennial tri-set family line where an unlimited number of distinctive yet compatible tri-sets can be designed. For example, a product design strategy consisting of a black, white and shades of grey color palette offers many solid color choices for the first shoe, unlimited pattern choices (stripes, polka dots, checks, plaids, etc.) for the second shoe and, of course, unlimited choices for the third “wildcard” shoe that has words, slogans, graffiti, artwork or other creative expression.

I claim:

1. A shoe container comprising three shoes.

2. The shoe container of claim one comprising three shoes in a container, with the shoes being either one right and two left shoes {RLL} or one left and two right shoes {LRR} wherein a purchaser of said container purchases two pairs of shoes by combining the one right shoe with either of the two left shoes or the one left shoe with either of the two right shoes.

3. The shoe container of claim two comprising both a matching and a mixed pair of shoes wherein a number indicates a distinctive individual shoe design in a tri-set product family notated as {R1L1L2} and {L1R1R2} providing matched pairs [R1L1] and [L1R1] respectively and a mixed pair [R1L2] and [L1R2] respectively.

4. The shoe container of claim two comprising three shoes with distinctive and compatible product designs using distinctly different designs for each shoe notated as {R1L2L3} and {L1R2R3} wherein the first tri-set is comprised of mixed pairs [R1L2] and [R1L3] and the second tri-set is comprised of [L1R2] and [L1R3] mixed pairs.

5. Two shoe containers comprising three shoes in each box with one right and two left shoes in one container and two right and one left shoe in the other container using compatible product design families for each tri-set such that together the two shoe containers provide nine distinct pairs of shoes.

6. The two shoe containers of claim five with the first tri-set comprised of {R1L2L3} and the second tri-set is {L1R2R3} yielding three matching and six mixed pairs of shoes, totally nine distinct pairs.

7. The two shoe containers of claim five with the first tri-set comprised of {R1L2L3} and the second tri-set comprised of {L4R5R6} yielding nine distinct mixed pairs of shoes.

8. Three or more shoe containers with each shoe container comprised of either one left and two right shoes or two left and one right shoe.

9. The method of manufacturing, marketing and sales of shoes comprised of; creating compatible product design for shoes; manufacturing the shoes with the compatible product designs; putting three shoes that are from a compatible product design in a shoe container, with the shoes being either two right and one left shoes or two left and one right shoes; marketing the shoe container with, a buy one shoe container get two pairs of shoes, marketing the shoe container with buy two shoe containers get nine pairs of shoes, buy three shoe containers get twenty pairs, buy four shoe containers get thirty-six pairs; buy five shoe containers get fifty-six pairs; buy six shoe containers get eighty-one pairs, based on the algorithm of each additional container purchase N=1→∞.
